(19) United States
(12) Patent Application Publication
(10) Pub. No.: US 2025/0354936 A1
(43) Pub. Date: Nov. 20, 2025

(54) Terminal Strip Inspection System and Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Middletown, PA (US); Lei (Alex) Zhou, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 19/207,824

(22) Filed: May 14, 2025

(30) Foreign Application Priority Data
May 14, 2024 (CN) 202410599195.X

(51) Int. Cl. G01N 21/88; B23K 37/047; G01N 21/84

(52) U.S. Cl. CPC G01N 21/8803; B23K 37/047; G01N 2021/8455

(57) ABSTRACT

A terminal strip inspection system includes a visual inspection module, a cutting module, and a conveying module. The visual inspection module installed at a visual inspection station visually inspects whether a quality of terminals on a terminal strip conveyed through the visual inspection station are qualified. The cutting module is installed at a cutting station and is located downstream of the visual inspection station. The conveying module conveys the terminal strip from back to front through the visual inspection station and the cutting station in sequence. When the terminal strip is loaded into the terminal strip inspection system, a front end area of the terminal strip is located downstream of the visual inspection station and has not undergone visual inspection. After the terminal strip is loaded, the terminal strip inspection system is activated and the cutting module cuts off the front end area of the terminal strip, so that uninspected areas in the terminal strip are not further conveyed through the terminal strip inspection system.

### CROSS-REFERENCE TO RELATED APPLICATION

This application claims the benefit of the filing date under 35 U.S.C. § 119 (a)-(d) of Chinese Patent Application No. CN202410599195.X filed on May 14, 2024.

### FIELD OF THE INVENTION

The present invention relates to an inspection system and, more particularly, to a terminal strip inspection system and a method for inspecting a terminal strip using the terminal strip inspection system.

### BACKGROUND OF THE INVENTION

In the prior art, in order to ensure the quality of terminals on a produced terminal strip, it is necessary to conduct quality inspection on the produced terminal strip. In the prior art, a visual inspection system is usually used to check whether the quality of the terminals on the terminal strip are qualified. The visual inspection system usually includes a visual inspection module, a cutting module, and a welding module arranged in sequence along the conveying direction of the terminal strip, as well as a first pin wheel arranged between the visual inspection module and the cutting module, and a second pin wheel arranged downstream of the welding module.

In the prior art, when loading the terminal strip into the visual inspection system, the visual inspection system is in a non-working shutdown state. The front end area of the terminal strip loaded into the visual inspection system is located downstream of the visual inspection module and engages with the first pin wheel to ensure that the terminal strip can be conveyed forward through the first pin wheel. However, due to the fact that the front end area of the terminal strip is located downstream of the visual inspection module and the visual inspection module is not yet working when loading the terminal strip, the front-end area of the loaded terminal strip downstream of the visual inspection module has not undergone visual inspection, which reduces the reliability of the quality inspection of the terminal strip which may still produce terminals with substandard quality.

### SUMMARY OF THE INVENTION

A terminal strip inspection system includes a visual inspection module, a cutting module, and a conveying module. The visual inspection module installed at a visual inspection station visually inspects whether a quality of terminals on a terminal strip conveyed through the visual inspection station are qualified. The cutting module is installed at a cutting station and is located downstream of the visual inspection station. The conveying module conveys the terminal strip from back to front through the visual inspection station and the cutting station in sequence. When the terminal strip is loaded into the terminal strip inspection system, a front end area of the terminal strip is located downstream of the visual inspection station and has not undergone visual inspection. After the terminal strip is loaded, the terminal strip inspection system is activated and the cutting module cuts off the front end area of the terminal strip, so that uninspected areas in the terminal strip are not further conveyed through the terminal strip inspection system.

### BRIEF DESCRIPTION OF DRAWINGS

The invention will now be described by way of example with reference to the accompanying figures, of which:

FIG. 1 is a perspective view of a terminal strip according to an exemplary embodiment;

FIG. 2 is a schematic view of a terminal strip inspection system according to an exemplary embodiment, in which the terminal strip of FIG. 1 has just been loaded into the terminal strip inspection system;

FIG. 3 is a schematic view of the terminal strip inspection system of FIG. 2, in which a front end area of the terminal strip of FIG. 1 that has not been visually inspected is cut off;

FIG. 4 is a schematic view of the terminal strip inspection system of FIG. 2, in which the terminal strip of FIG. 1 is conveyed forward through the terminal strip inspection system;

FIG. 5 is a schematic view of a terminal strip inspection system according to another exemplary embodiment of the present invention, in which the terminal strip of FIG. 1 has just been loaded into the terminal strip inspection system and a rear end of a previously inspected terminal strip is still in the system;

FIG. 6 is a schematic view of the terminal strip inspection system of FIG. 5, in which a front end of the loaded terminal strip of FIG. 5 is cut so that a front end edge of the loaded terminal strip is suitable for docking with a rear end of the previously inspected terminal strip of FIG. 5;

FIG. 7 is a schematic view of the terminal strip inspection system of FIG. 5, in which the front end edge of the loaded terminal strip of FIG. 5 and the rear end of the previously inspected terminal strip of FIG. 5 are welded together;

FIG. 8 is a schematic view of the terminal strip inspection system of FIG. 5, in which the loaded terminal strip of FIG. 5 is conveyed backwards so that the unchecked front end area of the loaded terminal strip returns to the visual inspection station; and

FIG. 9 is a schematic view of the terminal strip inspection system of FIG. 5, in which the loaded terminal strip of FIG. 5 is conveyed forward.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

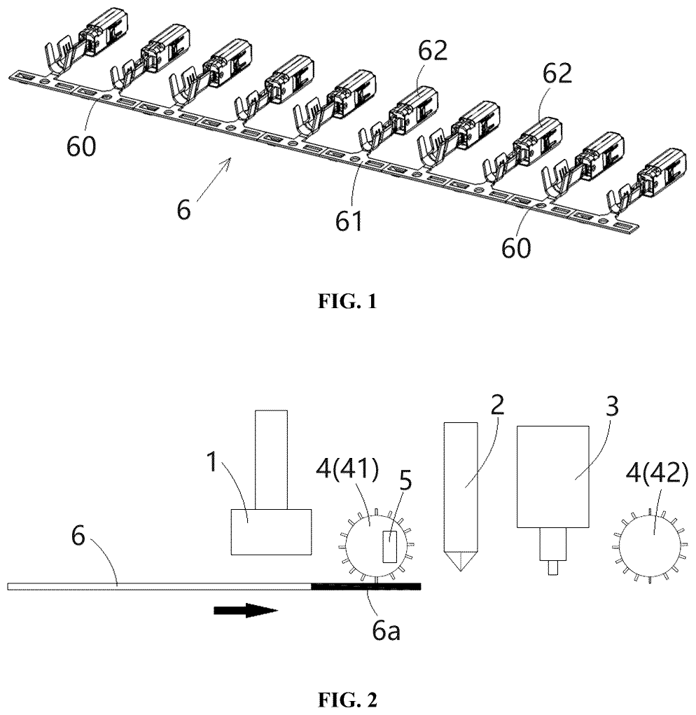

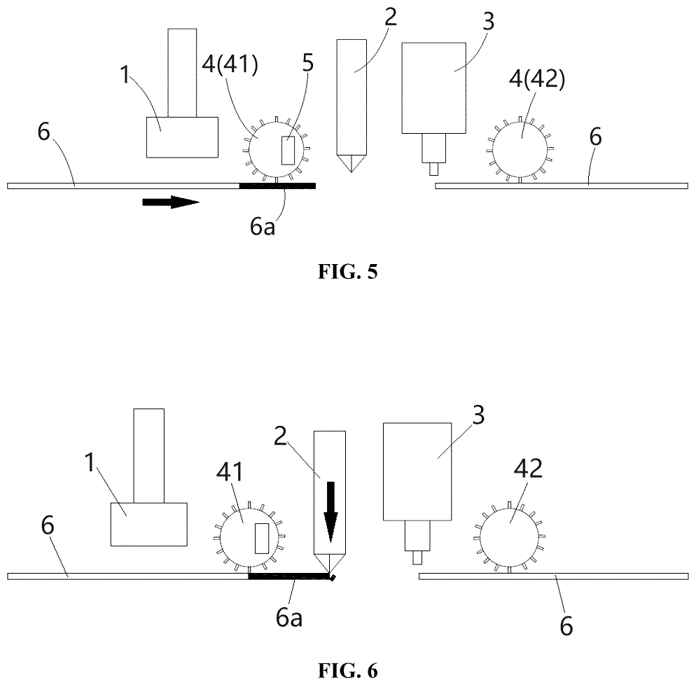

An exemplary embodiment of a terminal strip 6 is now described with reference to FIG. 1. As shown in FIG. 1, the terminal strip 6 has a carrier strip 61 and a row of terminals 62 connected to the carrier strip 61. In order to facilitate transportation and positioning of the terminal strip 6, positioning holes 60 suitable for the engagement of the pin wheels 41, 42 (see FIG. 2 or 5) are formed on the carrier strip 61.

An exemplary embodiment of a terminal strip inspection system is now described with reference to FIGS. 2-4. As shown in FIG. 2, the terminal strip inspection system comprises a visual inspection module 1, a cutting module 2, and a conveying module 4.

The visual inspection module 1, as shown in FIGS. 2-4, is installed at the visual inspection station to visually inspect whether the quality of the terminals 62 on the terminal strip 6 conveyed through the visual inspection station are qualified. The cutting module 2 is installed at the cutting station and located downstream of the visual inspection station. The cutting module 2 is used for cutting the terminal strip 6. The conveying module 4 is suitable for conveying the terminal strip 6 from back to front, passing through the visual inspection station and cutting station in sequence. When the terminal strip 6 is loaded into the terminal strip inspection system, a front end area 6a of the terminal strip 6 is located downstream of the visual inspection station and has not undergone visual inspection. After the terminal strip 6 is loaded, the terminal strip inspection system is activated and the unchecked front end area 6a of the terminal strip 6 is cut off by the cutting module 2, so that there are no areas of the terminal strip 6 that have not been visually inspected after being transported through the terminal strip inspection system; in other words, uninspected areas in the terminal strip are not further conveyed through the terminal strip inspection system.

As shown in FIG. 2, the conveying module 4 includes a first pin wheel 41, which is arranged between the visual inspection module 1 and the cutting module 2 and is suitable for engaging with the positioning holes 60 on the terminal strip 6. When the first pin wheel 41 is rotated forward, it pushes the terminal strip 6 forward.

When the terminal strip 6 is loaded into the terminal strip inspection system, the first pin wheel 41 engages with the positioning holes 60 on the front end area 6a of the terminal strip 6. When the terminal strip 6 is loaded into the terminal strip inspection system, the first one of the terminals 62 in the front end area 6a of the terminal strip 6 is in a predetermined position, so that the loaded terminal strip 6 is in a predetermined loading position.

As shown in FIG. 2, the terminal strip inspection system further includes a position sensor 5, which is installed on the first pin wheel 41 to detect whether the first one of the terminals 62 in the front end area 6a of the loaded terminal strip 6 is in the predetermined position, to ensure that the loaded terminal strip 6 is in the predetermined loading position.

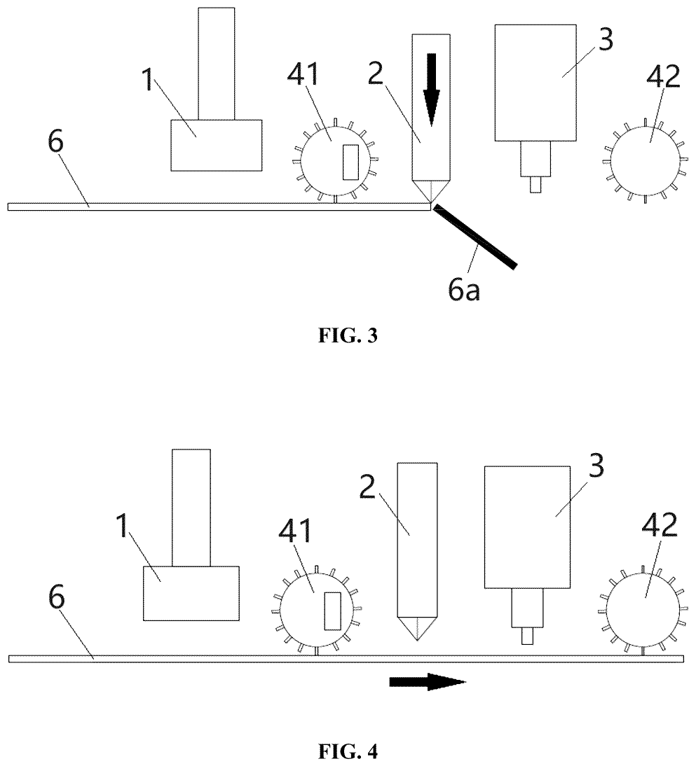

As shown in FIG. 3, when the visual inspection module 1 detects the presence of unqualified terminals 62 on the terminal strip 6, the cutting module 2 cuts off the unqualified terminals 62 from the terminal strip 6.

As shown in FIGS. 2-4, the terminal strip inspection system also includes a welding module 3. The welding module 3 is installed at the welding station and is downstream of the cutting station. The welding module 3 is used to weld two separate terminal strips 6 together. After the unqualified terminals 62 are cut off from the terminal strip 6 by the cutting module 2, the terminal strip 6 is divided into two separate sections, and the two separate sections are welded together by the welding module 3. The two separate sections are a rear section and a front section.

As shown in FIG. 2, the conveying module 4 further comprises a second pin wheel 42, which is arranged downstream of the welding module 3 and adapted to engage with the positioning holes 60 on the terminal strip 6. When the second pin wheel 42 is rotated forward, it pushes the terminal strip 6 forward and transports it to a terminal strip winding device.

After the terminal strip 6 is divided into two separate sections, the first pin wheel 41 and the second pin wheel 42 are respectively engaged with the rear section and the front section. The first pin wheel 41 moves the front end of the rear section of the terminal strip 6 to the position where it is docked with the rear end of the front section of the terminal strip 6. After the front end of the rear section of the terminal strip 6 is moved to the position where it is docked with the rear end of the front section of the terminal strip 6, the welding module 3 welds the front end of the rear section and the rear end of the front section together.

An exemplary embodiment of a terminal strip inspection method is now described with reference to FIGS. 1-4. The inspection method for the terminal strip includes a step S11: providing the terminal strip inspection system according to FIGS. 2-4. The method also includes a step S12: as shown in FIG. 2, loading a terminal strip 6 into the terminal strip inspection system, wherein the front end area 6a of the terminal strip 6 loaded into the terminal strip inspection system is located downstream of the visual inspection station and has not undergone visual inspection. The method further includes a step S13: as shown in FIGS. 3-4, after the terminal strip 6 is loaded into the terminal strip inspection system, the terminal strip inspection system is started and the uninspected front end area 6a of the terminal strip 6 is cut off by the cutting module 2, so that there is no uninspected area in the terminal strip 6 further conveyed through the terminal strip inspection system.

Another exemplary embodiment of a terminal strip inspection system is now described with reference to FIGS. 5-9. As shown in FIG. 5, the terminal strip inspection system comprises a visual inspection module 1, a cutting module 2, a welding module 3, and a conveying module 4.

The visual inspection module 1, as shown in FIGS. 5-9, is installed at the visual inspection station to visually inspect whether the quality of the terminals 62 on the terminal strip 6 conveyed through the visual inspection station are qualified. The cutting module 2 is installed at the cutting station and located downstream of the visual inspection station. The cutting module 2 is used for cutting the terminal strip 6. The welding module 3 is installed at the welding station and downstream of the cutting station. The welding module 3 is used to weld two separate terminal strips 6 together. The conveying module 4 is suitable for conveying the terminal strip 6 from back to front through the visual inspection station, the cutting station, and the welding station in sequence.

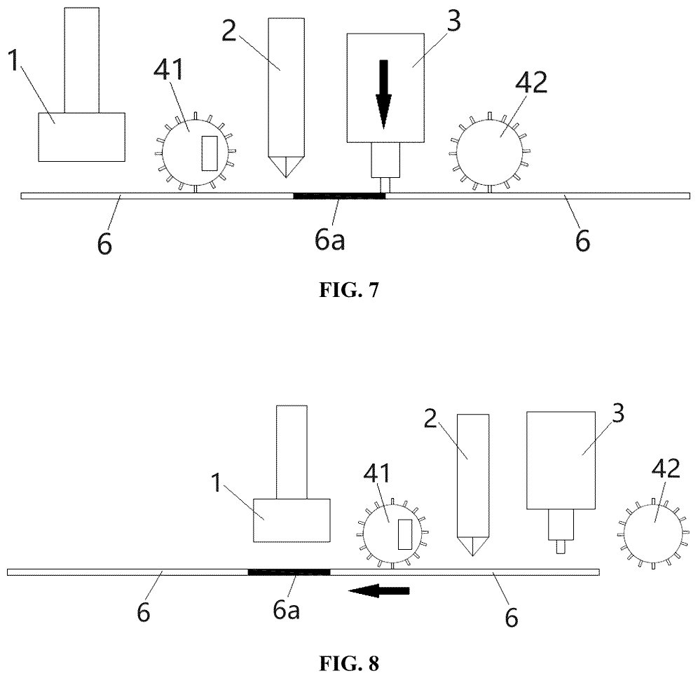

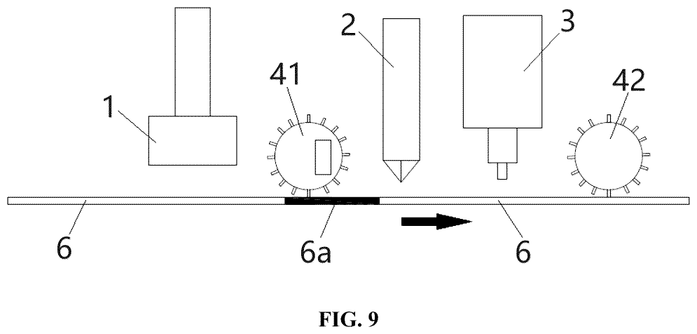

As shown in FIG. 5, when the terminal strip 6 is loaded into the terminal strip inspection system, the front end area 6a of the terminal strip 6 is located downstream of the visual inspection station and has not undergone visual inspection. As shown in FIG. 6, after the terminal strip 6 is loaded, the terminal strip inspection system starts and cuts the front end of the loaded terminal strip 6 by the cutting module 2 and forms a front end edge of the terminal strip. As shown in FIG. 7, the front end edge of the loaded terminal strip 6 is welded to the rear end of the inspected terminal strip 6 by the welding module 3. The inspected terminal strip 6 is a terminal strip 6 that has been previously inspected by the visual inspection module 1. As shown in FIGS. 8-9, the front end area 6a of the loaded terminal strip 6 is conveyed in reverse to the visual inspection station by the conveying module 4 to visually inspect the front end area 6a of the loaded terminal strip 6, and then the loaded terminal strip 6 is conveyed forward by the conveying module 4, so that there is no area of the terminal strip 6 that has not been visually inspected after passing through the terminal strip inspection system.

After the front end of the loaded terminal strip 6 is cut by the cutting module 2, the front end edge of the loaded terminal strip 6 is complementary to the rear end edge of the inspected terminal strip 6, so that the two can be seamlessly welded together by the welding module 3.

After the front end of the loaded terminal strip 6 and the rear end of the inspected terminal strip 6 are welded together by the welding module 3, the distance between the first one of the terminals 62 at the front end of the loaded terminal strip 6 and the last one of the terminals 62 at the rear end of the inspected terminal strip 6 is equal to the pitch between any two adjacent terminals 62 on the terminal strip 6.

As shown in FIG. 5, the conveying module 4 includes a first pin wheel 41, which is arranged between the visual inspection module 1 and the cutting module 2 and is suitable for engaging with the positioning holes 60 on the terminal strip 6. When the first pin wheel 41 is rotated forward, it pushes the terminal strip 6 forward. When the terminal strip 6 is loaded into the terminal strip inspection system, the first pin wheel 41 engages with the positioning holes 60 on the front end area 6a of the loaded terminal strip 6. When the terminal strip 6 is loaded into the terminal strip inspection system, the first one of the terminals 62 in the front end area 6a of the loaded terminal strip 6 is in a predetermined position, so that the loaded terminal strip 6 is in the predetermined loading position.

As shown in FIG. 5, the terminal strip inspection system further includes a position sensor 5, which is installed on the first pin wheel 41 to detect whether the first one of the terminals 62 in the front end area 6a of the loaded terminal strip 6 is in the predetermined position, to ensure that the loaded terminal strip 6 is in the predetermined loading position.

As shown in FIG. 6, when the visual inspection module 1 detects the presence of unqualified terminals 62 on the terminal strip 6, the cutting module 2 cuts off the unqualified terminals 62 from the terminal strip 6.

As shown in FIGS. 6-7, after cutting off the unqualified terminals 62 from the terminal strip 6 by the cutting module 2, the terminal strip 6 is divided into two separate sections, and the two separate sections are welded together by the welding module 3. The two separate sections are a rear section and a front section.

As shown in FIG. 5, the conveying module 4 further comprises a second pin wheel 42, which is arranged downstream of the welding module 3. The second pin wheel 42 is adapted to engage with the positioning holes 60 on the terminal strip 6. When the second pin wheel 42 is rotated forward, it pushes the terminal strip 6 forward and transports it to the terminal strip winding device.

After the terminal strip 6 is divided into the two separate sections, the first pin wheel 41 and the second pin wheel 42 are respectively engaged with the rear section and the front section. The first pin wheel 41 moves the front end of the rear section of the terminal strip 6 to the position where it is docked with the rear end of the front section of the terminal strip 6. After the front end of the rear section of the terminal strip 6 is moved to the position where it is docked with the rear end of the front section of the terminal strip 6, the welding module 3 welds the front end of the rear section of the terminal strip 6 and the rear end of the front section of the terminal strip 6 together.

As shown in FIG. 8, during the process of conveying the front end area 6a of the loaded terminal strip 6 to the visual inspection station in reverse by the conveying module 4, the first pin wheel 41 and the second pin wheel 42 are rotated synchronously backward. As shown in FIG. 9, during the process of conveying the terminal strip 6 forward by the conveying module 4, the first pin wheel 41 and the second pin wheel 42 are rotated synchronously forward.

Another exemplary embodiment of a terminal strip inspection method is now described with reference to FIGS. 5-9. The inspection method for the terminal strip includes a step S21: providing the terminal strip inspection system according to FIGS. 5-9. The method also includes a step S22: as shown in FIG. 5, the terminal strip 6 is loaded into the terminal strip inspection system, the front end area 6a of the terminal strip 6 loaded into the terminal strip inspection system is located downstream of the visual inspection station and has not undergone visual inspection. The method further includes a step S23: as shown in FIG. 6, start the terminal strip inspection system and cut the front end off of the loaded terminal strip 6 by the cutting module 2 thereby forming a front end edge of the terminal strip. The method further includes a step S24: as shown in FIG. 7, the front end edge of the loaded terminal strip 6 and the rear end of the inspected terminal strip 6 are welded together through welding module 3. The method further includes a step S25: as shown in FIG. 8, the front end area 6a of the loaded terminal strip 6 is conveyed in reverse to the visual inspection station by the conveying module 4 to visually inspect the front end area 6a of the loaded terminal strip 6. The method further includes a step S26: as shown in FIG. 9, the loaded terminal strip 6 is conveyed forward by the conveying module 4, so that the front end area 6a of the loaded terminal strip 6 passes through the visual inspection station and is visually inspected.

In the aforementioned exemplary embodiments according to the present invention, the terminal strip inspection system can ensure that there are no areas on the produced terminal strip 6 that have not been visually inspected, thereby improving the reliability of terminal strip quality inspection.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A terminal strip inspection system, comprising:
a visual inspection module installed at a visual inspection station visually inspecting whether a quality of terminals on a terminal strip conveyed through the visual inspection station are qualified;
a cutting module installed at a cutting station and located downstream of the visual inspection station; and
a conveying module conveying the terminal strip from back to front through the visual inspection station and the cutting station in sequence, when the terminal strip is loaded into the terminal strip inspection system, a front end area of the terminal strip is located downstream of the visual inspection station and has not undergone visual inspection, after the terminal strip is loaded, the terminal strip inspection system is activated and the cutting module cuts off the front end area of the terminal strip, so that uninspected areas in the terminal strip are not further conveyed through the terminal strip inspection system.

2. The terminal strip inspection system of claim 1, wherein the conveying module has a first pin wheel between the visual inspection module and the cutting module, the first pin wheel meshes with positioning holes on the terminal strip, when the first pin wheel rotates forward the first pin wheel pushes the terminal strip forward for transportation, the first pin wheel engages with the positioning holes on the front end area of the terminal strip when the terminal strip is loaded into the terminal strip inspection system.

3. The terminal strip inspection system of claim 2, wherein a first terminal in the front end area of the terminal strip is in a predetermined position when the terminal strip is loaded into the terminal strip inspection system, so that the terminal strip is in a predetermined loading position.

4. The terminal strip inspection system of claim 3, further comprising a position sensor installed on the first pin wheel ensuring that the terminal strip is in the predetermined loading position, the position sensor detects whether the first terminal in the front end area of the terminal strip is in the predetermined position.

5. The terminal strip inspection system of claim 4, wherein the cutting module cuts off unqualified terminals from the terminal strip when the visual inspection module detects a presence of unqualified terminals on the terminal strip.

6. The terminal strip inspection system of claim 5, further comprising a welding module installed at a welding station and located downstream of the cutting station, after the cutting module cuts off unqualified terminals from the terminal strip, the terminal strip is divided into two separate sections, the two separate sections are welded together by the welding module.

7. The terminal strip inspection system of claim 6, wherein the conveying module has a second pin wheel downstream of the welding module, the second pin wheel meshes with the positioning holes on the terminal strip, when the second pin wheel rotates forward the second pin wheel pushes the terminal strip forward and transports the terminal strip to a terminal strip winding device.

8. The terminal strip inspection system of claim 7, wherein the two separate sections are a rear section and a front section, the first pin wheel is engaged with the rear section and the second pin wheel is engaged with the front section, the first pin wheel moves a front end of the rear section to a position where it is docked with a rear end of the front section, the welding module welds the front end of the rear section and the rear end of the front section together.

9. A terminal strip inspection method, comprising:
loading a terminal strip into a terminal strip inspection system, a front end area of the terminal strip loaded into the terminal strip inspection system is located downstream of a visual inspection station of the terminal strip inspection system and has not undergone visual inspection; and
cutting off the front end area of the terminal strip to ensure no uninspected area in the terminal strip is further conveyed through the terminal strip inspection system.

10. A terminal strip inspection system, comprising:
a visual inspection module installed at a visual inspection station visually inspecting whether a quality of terminals on a terminal strip conveyed through the visual inspection station are qualified;
a cutting module installed at a cutting station and located downstream of the visual inspection station;
a welding module installed at a welding station and downstream of the cutting station; and
a conveying module conveying the terminal strip from back to front through the visual inspection station, the cutting station, and the welding station in sequence, when the terminal strip is loaded into the terminal strip inspection system, a front end area of the terminal strip is located downstream of the visual inspection station and has not undergone visual inspection, after the terminal strip is loaded, the terminal strip inspection system is activated and the cutting module cuts off a front end of the terminal strip forming a front end edge of the terminal strip, the welding module welds the front end edge of the terminal strip and a rear end of an inspected terminal strip together, the conveying module transports the front end area of the terminal strip in reverse to the visual inspection station to visually inspect the front end area of the terminal strip, and the conveying module transports the terminal strip forward, so that the terminal strip that has been transported through the terminal strip inspection system does not have any areas that have not been visually inspected by the terminal strip inspection system.

11. The terminal strip inspection system of claim 10, wherein after the front end of the terminal strip is cut off, the front end edge of the terminal strip is complementary to a rear end edge of the inspected terminal strip, the welding module seamlessly welds the terminal strip and the inspected terminal strip together.

12. The terminal strip inspection system of claim 10, wherein after the terminal strip and the inspected terminal strip are welded together, a distance between a first terminal at the front end area of the terminal strip and a last terminal at the rear end of the inspected terminal strip are equal to a pitch between any two adjacent terminals on the terminal strip.

13. The terminal strip inspection system of claim 10, wherein the conveying module has a first pin wheel between the visual inspection module and the cutting module, the first pin wheel meshes with positioning holes on the terminal strip, when the first pin wheel rotates forward the first pin wheel pushes the terminal strip forward for transportation, the first pin wheel engages with the positioning holes on the front end area of the terminal strip when the terminal strip is loaded into the terminal strip inspection system.

14. The terminal strip inspection system of claim 13, wherein a first terminal in the front end area of the terminal strip is in a predetermined position when the terminal strip is loaded into the terminal strip inspection system, so that the terminal strip is in a predetermined loading position.

15. The terminal strip inspection system of claim 14, further comprising a position sensor installed on the first pin wheel ensuring that the terminal strip is in the predetermined loading position, the position sensor detects whether the first terminal in the front end area of the terminal strip is in the predetermined position.

16. The terminal strip inspection system of claim 15, wherein when the visual inspection module detects a presence of unqualified terminals on the terminal strip, the cutting module cuts off unqualified terminals from the terminal strip and divides the terminal strip into two separate sections, the two separate sections are welded together by the welding module.

17. The terminal strip inspection system of claim 16, wherein the conveying module has a second pin wheel downstream of the welding module, the second pin wheel meshes with the positioning holes on the terminal strip, when the second pin wheel rotates forward the second pin wheel pushes the terminal strip forward and transports the terminal strip to a terminal strip winding device.

18. The terminal strip inspection system of claim 17, wherein the two separate sections are a rear section and a front section, the first pin wheel is engaged with the rear section and the second pin wheel is engaged with the front section, the first pin wheel moves a front end of the rear section to a position where it is docked with a rear end of the front section, the welding module welds the front end of the rear section and the rear end of the front section together.

19. The terminal strip inspection system of claim 17, wherein the first pin wheel and the second pin wheel synchronously rotate backward when the conveying module conveys the front end area of the terminal strip in reverse to the visual inspection station, and the first pin wheel and the second pin wheel synchronously rotate forward when the conveying module conveys the terminal strip forward.

20. A terminal strip inspection method, comprising:
loading a terminal strip into a terminal strip inspection system, a front end area of the terminal strip loaded into the terminal strip inspection system is located downstream of a visual inspection station of the terminal strip inspection system and has not undergone visual inspection;
cutting a front end off of the terminal strip with a cutting module of the terminal strip inspection system and forming a front end edge of the terminal strip;
welding the front end edge of the terminal strip and a rear end of an inspected terminal strip together with a welding module of the terminal strip inspection system;
transporting the front end area of the terminal strip in reverse to the visual inspection station of the terminal strip inspection system by a conveying module of the terminal strip inspection system; and
transporting the terminal strip forward by the conveying module, so that the front end area of the terminal strip passes through the visual inspection station and is visually inspected.
